(19) United States
(12) Patent Application Publication
(10) Pub. No.: US 2020/0334481 A1
(43) Pub. Date: Oct. 22, 2020

(54) IMAGE PROCESSING APPARATUS, METHOD FOR DETECTING EVENT FROM IMAGE, AND STORAGE MEDIUM

(71) Applicant: CANON KABUSHIKI KAISHA, Tokyo (JP)

(72) Inventors: Hiroki Makita, Tokyo (JP); Shunsuke Sato, Kawasaki-shi (JP); Koichi Takeuchi, Yokohama-shi (JP); Yasuhiro Komori, Tokyo (JP)

(21) Appl. No.: 16/847,890

(22) Filed: Apr. 14, 2020

(30) Foreign Application Priority Data
Apr. 22, 2019 (JP) 2019-080895

(51) Int. Cl. G06K 9/00

(52) U.S. Cl. CPC G06K 9/00979; G06K 9/00771

(57) ABSTRACT

An information processing apparatus includes a first detection unit configured to detect an event from a captured image through first detection processing, a resource management unit configured to allocate a resource allocated to predetermined processing to second detection processing different from the first detection processing in a case where the event is detected through the first detection processing, and a second detection unit configured to detect an event from the captured image through the second detection processing using the resource allocated by the resource management unit.

### BACKGROUND OF THE INVENTION

### Field of the Invention

The present invention relates to an image processing apparatus, a method for detecting an event from an image, and a storage medium.

### Description of the Related Art

A monitoring system that analyzes a behavior pattern of a person or a crowd from image or video data acquired by a monitoring camera, detects a specific event, and notifies a monitoring person of the detected event is widely known. Such a monitoring system sequentially acquires captured images from a plurality of monitoring cameras and performs event detection processing. If an event is detected, the monitoring system notifies a monitoring person of the detected event.

There are demands for increasing the number of monitoring cameras to be connected to a monitoring system in order to monitor a wider area. Japanese Patent Application Laid-Open No. 2007-243699 discusses a system that is connected with a plurality of cameras. Japanese Patent Application Laid-Open No. 2007-243699 discusses a monitoring system that records a more detailed captured image by changing a frame rate or resolution of a captured image acquired from a specific camera in a case where an event is detected from the image captured by the specific camera.

However, processing resources of a system including a calculation apparatus, such as a central processing unit (CPU) or graphics processing unit (GPU), a storage apparatus, and a network configured to connect a monitoring camera with the system are limited. Thus, as the number of monitoring cameras connected to the monitoring system increases, the processing resources that can be allocated to each camera decrease. In general, there is a correlation between the processing resources and detection accuracy, and with decreased resources, the detection accuracy of detection processing decreases and erroneous notifications increase. Frequent erroneous notifications increase a burden on the monitoring person, so that it is desirable to efficiently allocate the processing resources and detect an event with great accuracy.

Thus, there is a need in the art for increasing the accuracy of event detection from captured images.

### SUMMARY OF THE INVENTION

According to an aspect of the present disclosure, an information processing apparatus includes a first detection unit configured to detect an event from a captured image through first detection processing, a resource management unit configured to allocate a resource allocated to predetermined processing to second detection processing different from the first detection processing in a case where the event is detected through the first detection processing, and a second detection unit configured to detect an event from the captured image through the second detection processing using the resource allocated by the resource management unit.

Further features of the present disclosure will become apparent from the following description of exemplary embodiments with reference to the attached drawings.

### BRIEF DESCRIPTION OF THE DRAWINGS

FIG. 1 is a block diagram illustrating an entire information processing system according to a first exemplary embodiment.

FIG. 2 is a block diagram illustrating a functional configuration of the information processing system.

FIG. 3 is a diagram illustrating primary event detection.

FIG. 4 is a diagram illustrating an example of a setting screen.

FIGS. 5A, 5B, and 5C are diagrams illustrating second detection processing and resource allocation processing.

FIG. 6 is a flowchart illustrating a process of information processing.

FIG. 7 is a flowchart illustrating a process of the second detection processing.

FIG. 8 is a block diagram illustrating a functional configuration of an information processing system according to a second exemplary embodiment.

FIG. 9 is a block diagram illustrating a functional configuration of an information processing system according to a third exemplary embodiment.

### DESCRIPTION OF THE EMBODIMENTS

Various exemplary embodiments of the present disclosure will be described below with reference to the drawings.

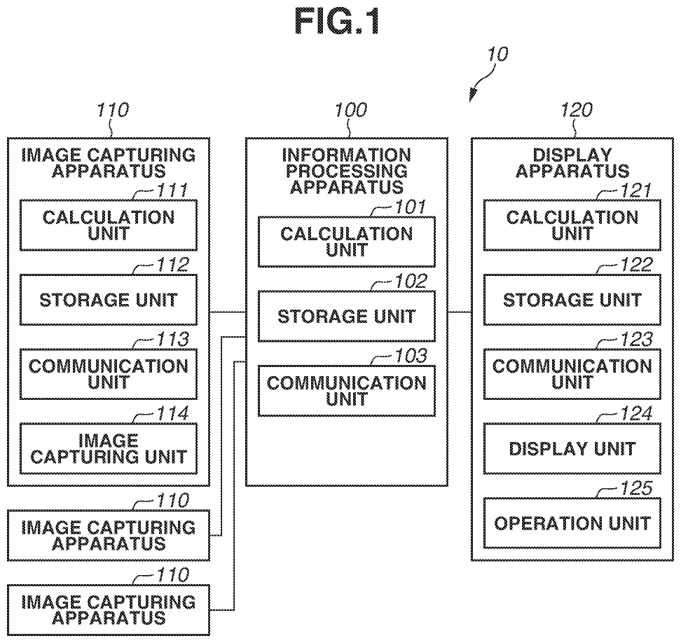

FIG. 1 is a diagram illustrating an entire information processing system according to a first exemplary embodiment. An information processing system 10 includes an information processing apparatus 100, a plurality of image capturing apparatuses 110, and a display apparatus 120. The information processing apparatus 100 is connected to each of the plurality of image capturing apparatuses 110 and the display apparatus 120 via a network. Each of the image capturing apparatuses 110 is disposed to capture an image of a monitoring region. While three image capturing apparatuses 110 are illustrated in FIG. 1, the number of the image capturing apparatuses 110 is not limited.

The information processing apparatus 100 includes a calculation unit 101, a storage unit 102, and a communication unit 103. The calculation unit 101 is a central processing unit (CPU) or a micro-processing unit (MPU) and controls the entire information processing apparatus 100. The storage unit 102 stores various types of information and programs. The communication unit 103 communicates with an external apparatus. The calculation unit 101 reads a program stored in the storage unit 102 and executes the read program to implement a function or process of the information processing apparatus 100 described below.

Each of the image capturing apparatuses 110 includes a calculation unit 111, a storage unit 112, a communication unit 113, and an image capturing unit 114. The calculation unit 111, the storage unit 112, and the communication unit 113 are respectively similar to the calculation unit 101, the storage unit 102, and the communication unit 103. The image capturing unit 114 captures an image. While the image capturing unit 114 captures a moving image in the present exemplary embodiment, the image capturing unit 114 can capture a still image.

The display apparatus 120 includes a calculation unit 121, a storage unit 122, a communication unit 123, a display unit 124, and an operation unit 125. The calculation unit 121, the storage unit 122, and the communication unit 123 are respectively similar to the calculation unit 101, the storage unit 102, and the communication unit 103. The display unit 124 displays various types of information. The operation unit 125 receives a user operation.

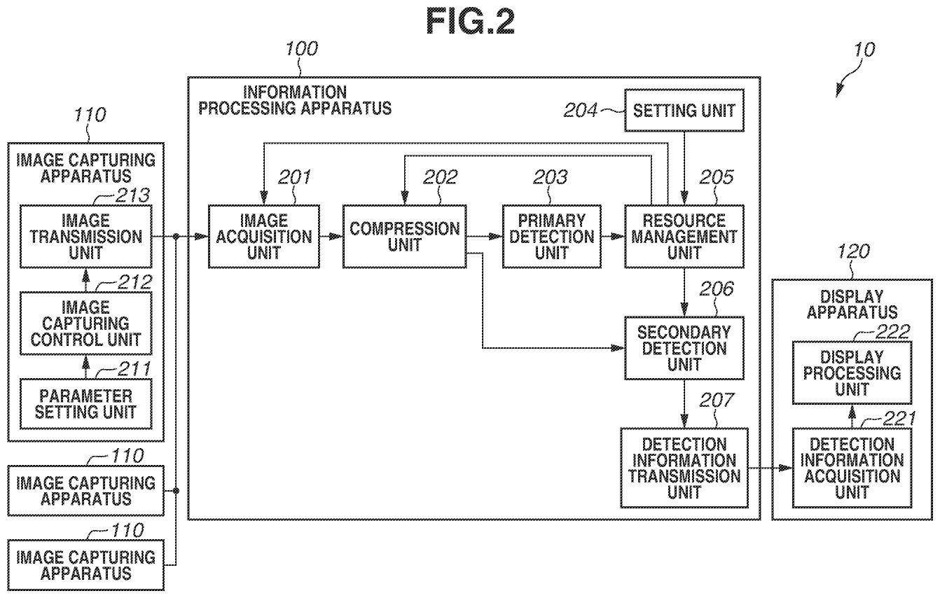

FIG. 2 is a block diagram illustrating a functional configuration of the information processing system 10. The information processing apparatus 100 sequentially acquires an image from each of the three image capturing apparatuses 110 and performs event detection based on the acquired image. In a case where an event is detected, the information processing apparatus 100 transmits detection information about the event to the display apparatus 120. If the detection information is received, the display apparatus 120 displays, on the display unit 124, notification information that indicates that the event is detected.

The information processing apparatus 100 includes an image acquisition unit 201, a compression unit 202, a primary detection unit 203, a setting unit 204, a resource management unit 205, a secondary detection unit 206, and a detection information transmission unit 207. The image capturing apparatus 110 includes an image capturing control unit 212, a parameter setting unit 211, and an image transmission unit 213. The display apparatus 120 includes a detection information acquisition unit 221 and a display processing unit 222.

The image capturing control unit 212 of the image capturing apparatus 110 controls image capturing performed by the image capturing unit 114 based on an image capturing parameter set by the parameter setting unit 211. The image transmission unit 213 transmits an image captured by the image capturing unit 114 to the information processing apparatus 100 in response to an acquisition request from the information processing apparatus 100.

The image acquisition unit 201 of the information processing apparatus 100 transmits an image acquisition request to the image capturing apparatuses 110 in predetermined order and acquires an image transmitted from the image capturing apparatuses 110. The compression unit 202 compresses the image acquired by the image acquisition unit 201 using a preset compression method (compression rate) to change the resolution of the images. The compression method can be set as a percentage, such as 50%, or as screen resolution or dots per inch (dpi), such as 4K or full high definition (Full HD). The order of image acquisition by the image acquisition unit 201 and the method of compression (compression rate) by the compression unit 202 can be changed by the setting unit 204 described below.

The primary detection unit 203 performs event detection on the image compressed by the compression unit 202. Hereinafter, the event detection performed by the primary detection unit 203 will be referred to as primary event detection, and the event detection performed by the secondary detection unit 206 will be referred to as secondary event detection, in order to discriminate between the event detections by the primary detection unit 203 and by the secondary detection unit 206. In the present exemplary embodiment, the primary detection unit 203 detects three types of abnormal actions of a person, which are a fall, a crouch, and shoplifting, as an event. The number and type of detection target events are not limited to those in the exemplary embodiments. As another example, the primary detection unit 203 can detect presence of a specific object such as a person or vehicle as an event.

As an event detection method, for example, a human body detection method that uses deep neural networks (DNN), as discussed in “You Only Look Once: Unified, RealTime Object Detection”, International Conference on Computer Vision and Pattern Recognition 2016, can be employed.

In a case where an action such as an abnormal action is to be estimated, for example, the primary detection unit 203 can detect an event based on a posture feature acquired by a method discussed in “Realtime Multi-Person 2D Pose Estimation using Part Affinity Fields”, Zhe Cao, Tomas Simon, Shih-En Wei, Yaser Sheikh, arxiv 2017.

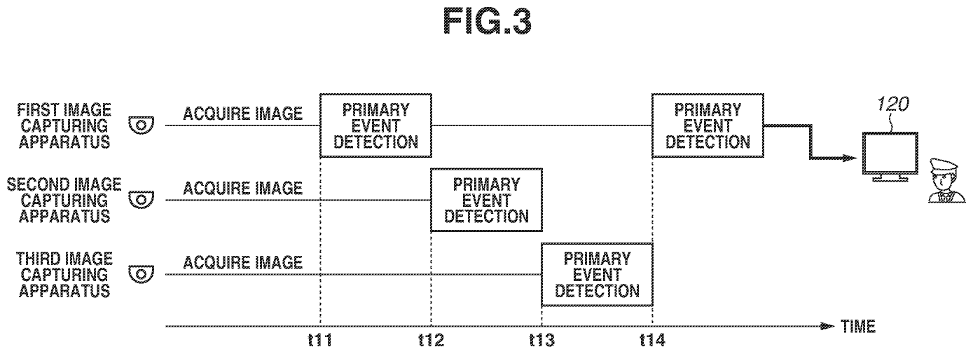

FIG. 3 is a diagram illustrating the primary event detection by the primary detection unit 203. The horizontal axis represents time. Hereinafter, the three image capturing apparatuses 110 will be referred to as a first image capturing apparatus, a second image capturing apparatus, and a third image capturing apparatus to differentiate between the three image capturing apparatuses 110. Further, images that are captured by the first image capturing apparatus, the second image capturing apparatus, and the third image capturing apparatus and are compressed by the compression unit 202 will be respectively referred to as a first image, a second image, and a third image. The primary detection unit 203 performs primary event detection on the first image, the second image, and the third image in this order. More specifically, first, at timing t11, the primary detection unit 203 performs the primary event detection on the first image. Then, after the processing on the first image is completed, at timing 12, the primary detection unit 203 performs the primary event detection on the second image. Next, after the processing on the second image is completed, at timing t13, similarly, the primary detection unit 203 performs the primary event detection on the third image, and at timing t14, the primary detection unit 203 performs the detection processing again on the first image.

As described above, the calculation unit 101 allocates resources of the calculation unit 101 as the primary detection unit 203 to the primary event detection performed on the first to third images. The information processing apparatus 100 according to the present exemplary embodiment changes the allocation of the resources of the calculation unit 101 in a case where an event is detected. This processing will be described in detail below. Hereinafter, a series of processing including the image compression by the compression unit 202 and the primary event detection by the primary detection unit 203 will be referred to as first detection processing.

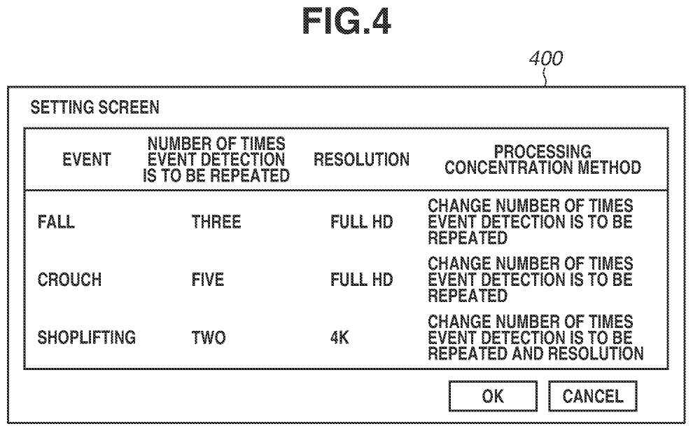

Referring back to FIG. 2, the setting unit 204 makes settings of the processing to be executed by the secondary detection unit 206 and the resource allocation in the resource management unit 205. The setting unit 204 makes a setting based on a user operation on a screen of the display apparatus 120. FIG. 4 illustrates an example of a setting screen 400 displayed on the display unit 124 of the display apparatus 120. The setting screen 400 displays the number of times the event detection is to be repeated by the secondary detection unit 206, resolution of an event detection target image, and a processing concentration method for each event. A user can change the number of times the event detection is to be repeated and the resolution of the target image to desired settings on the setting screen 400. The greater the number of times the event detection is to be repeated, or the higher the resolution of the target image, the higher the expected detection accuracy. For example, in a case where the number of times the event detection is to be repeated is set to three, the processing of repeating the event detection three times is set as second detection processing. For example, in a case where the number of times the event detection is to be repeated is two and the resolution is 4K, the processing of repeating the event detection twice and performing the event detection on a 4K image (image with a higher resolution than a normal Full HD image) is set as the second detection processing.

The setting unit 204 make the setting based on content input to the setting screen 400. As another example, the setting unit 204 can set one setting of the number of times the event detection is to be repeated, the resolution of the target image, and the second detection processing and the resource allocation, regardless of an event type. In this case, similar detection processing is performed and similar resource allocation is performed regardless of an event type.

Referring back to FIG. 2, in a case where an event is detected by the primary detection unit 203, the resource management unit 205 makes a setting based on the second detection processing set by the setting unit 204. More specifically, the resource management unit 205 instructs the image acquisition unit 201 to acquire an image from the image capturing apparatus that has captured the image from which the event is detected. The resource management unit 205 further instructs the compression unit 202 to perform compression using a designated compression rate and instructs the secondary detection unit 206 to execute the event detection the designated number of times. In a case where an event is detected by the primary detection unit 203, the secondary detection unit 206 performs the event detection the number of times designated by the resource management unit 205 on an image acquired by the image capturing apparatus that has captured the image from which the event is detected. In a case where the event detection is executed a plurality of times, the secondary detection unit 206 determines a comprehensive detection result based on a majority of the detection results.

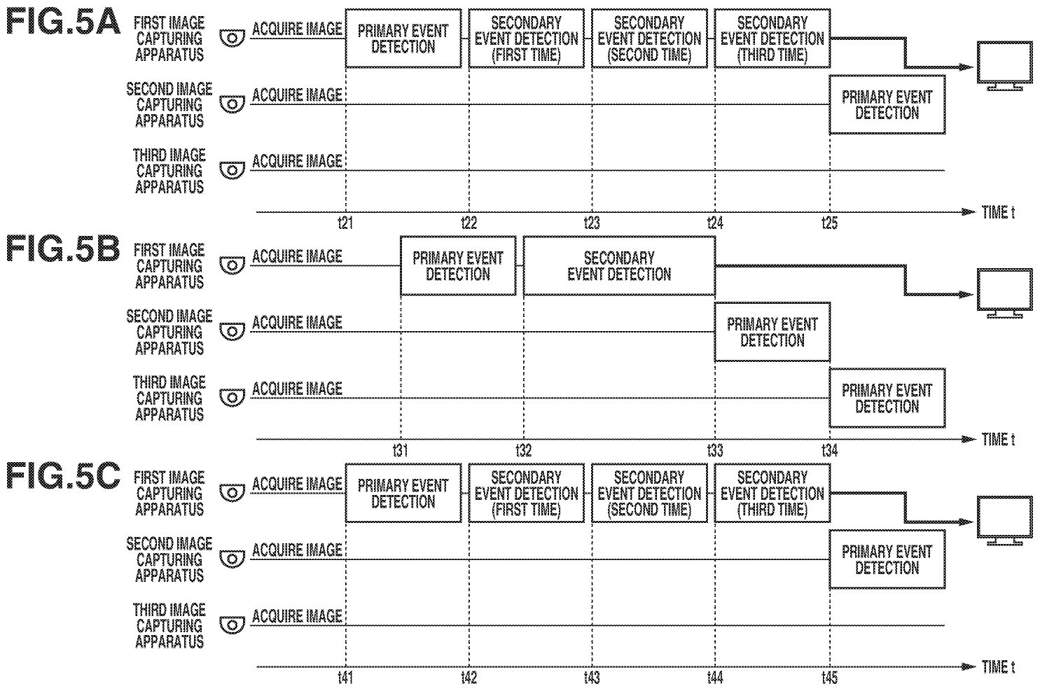

FIGS. 5A, 5B, and 5C are diagrams illustrating the second detection processing and the resource allocation processing. The second detection processing has three types. In the first type of the second detection processing, the number of times the detection processing is to be performed is greater than that in the first detection processing. In the second type of the second detection processing, the resolution of the target image is higher than that in the first detection processing. In the third type of the second detection processing, the number of times the detection processing is to be performed is greater than that in the first detection processing, and the resolution of the target image is higher than that in the first detection processing. The three types of the second detection processing will be described below using an example of a case where an event is detected in the primary event detection performed on an image captured by the first image capturing apparatus.

FIG. 5A is a diagram illustrating a case where the processing of repeating the event detection three times is performed as the second detection processing. As illustrated in FIG. 5A, the primary detection unit 203 performs the primary event detection on the first image at timing t21. In a case where an event is not detected, the primary detection unit 203 subsequently performs the first detection processing on the second image as described above with reference to FIG. 3. More specifically, the resources of the calculation unit 101 is allocated to the second image. On the other hand, in a case where an event is detected, the secondary detection unit 206 performs the first secondary event detection on the first image at subsequent timing t22 as illustrated in FIG. 5A. The secondary detection unit 206 subsequently performs the second secondary event detection at timing t23 and the third secondary event detection at timing t24 on the first image and determines a comprehensive detection result. Thus, the resources of the calculation unit 101 is allocated to the first image also at the timings t22 to t24. Then, at timing t25, the primary detection unit 203 performs the primary event detection on the second image in normal processing order.

FIG. 5B is a diagram illustrating a case where the processing of performing the event detection on a detection target image with a higher resolution than that of the detection target image in the primary event detection is performed as the second detection processing. The primary detection unit 203 performs the primary event detection on the first image at timing t31. If an event is detected, then at subsequent timing t32, the secondary detection unit 206 performs the secondary event detection on the first image. Thus, in the example illustrated in FIG. 5B, the resources of the calculation unit 101 is allocated to the first image also at timing t32. Further, since the processing target image is a high-quality image, the processing time of the secondary event detection is longer than that of the primary event detection. If the secondary event detection is ended, the primary detection unit 203 performs the primary event detection on the second image at timing t33 and performs the primary event detection on the third image at timing t34.

FIG. 5C is a diagram illustrating a case where the second detection processing is performed in which the detection is performed three times and the detection target is a high-resolution image. The primary detection unit 203 performs the primary event detection on the first image at timing t41. If an event is detected, the secondary detection unit 206 performs the secondary event detection on the first image at subsequent timing t42. Since the processing target image is a high-quality image, the processing time of the secondary event detection is longer than that of the primary event detection. Then, at timings t43 and t44, the secondary detection unit 206 performs the secondary event detection on the first image. Then, at timing 45, the primary detection unit 203 performs the primary event detection on the second image.

Referring back to FIG. 2, in a case where an event is detected by the secondary detection unit 206, the detection information transmission unit 207 transmits detection information indicating that an event is detected to the display apparatus 120. The detection information acquisition unit 221 of the display apparatus 120 acquires the detection information from the information processing apparatus 100. The display processing unit 222 performs control so that the detection information is displayed on the display unit 124.

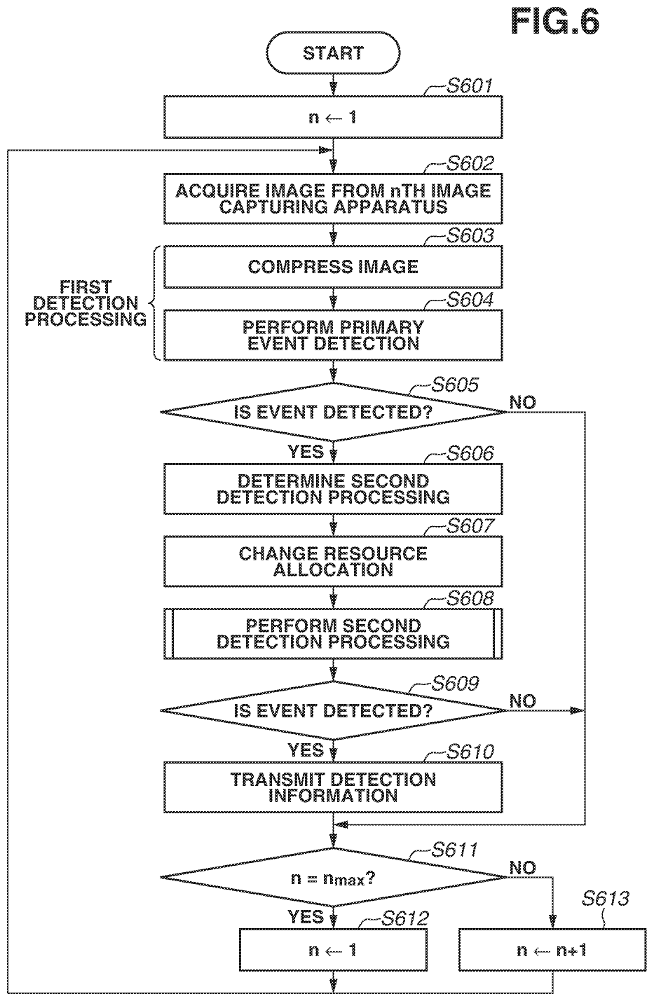

FIG. 6 is a flowchart illustrating a process of information processing performed by the information processing apparatus 100. By the time when the process is started, the second detection processing and the resource allocation for each event are set to the resource management unit 205 by the setting unit 204. In step S601, the image acquisition unit 201 sets 1 to n. Next, in step S602, the image acquisition unit 201 transmits an image acquisition request to the nth image capturing apparatus in processing order, and the image acquisition unit 201 acquires an image from the nth image capturing apparatus. At the start of the process, the image acquisition unit 201 acquires an image from the first image capturing apparatus. Next, in step S603, the compression unit 202 compresses the acquired image using the preset compression method to change the resolution. Next, in step S604, the primary detection unit 203 performs the primary event detection on the compressed image. In a case where an event is detected in the primary event detection (YES in step S605), the processing proceeds to step S606. In a case where an event is not detected in the primary event detection (NO in step S605), the processing proceeds to step S611.

Next, in step S606, the resource management unit 205 determines the second detection processing based on the event detected in the primary event detection. In a case where the event is a fall, for example, the resource management unit 205 determines the processing of repeating the detection processing three times as the second detection processing. In a case where the event is a crouch, the resource management unit 205 determines the processing of repeating the event detection five times as the second detection processing. In a case where the event is shoplifting, the resource management unit 205 determines the processing in which the event detection is repeated twice and the first event detection and the second event detection are each performed on a high-resolution image as the second detection processing. This processing is an example of the detection processing determination processing. In step S607, the resource management unit 205 changes the allocation of the resources of the calculation unit 101 from the primary event detection on an image acquired from the (n+1)th image capturing apparatus, to which the resources are supposed to be allocated, to the secondary event detection on an image acquired from the nth image capturing apparatus that is a processing target at the time of processing. Next, in step S608, the resource management unit 205 performs the second detection processing on the image acquired from the nth image capturing apparatus.

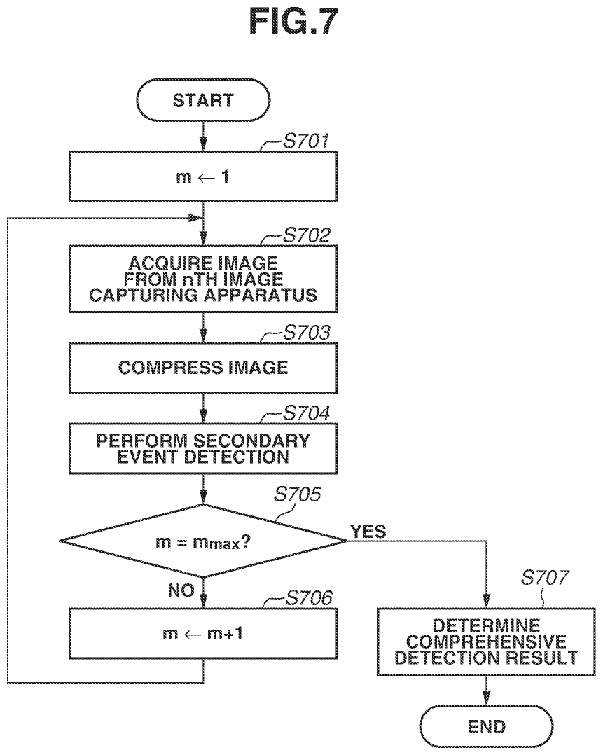

FIG. 7 is a flowchart illustrating a detailed process of the second detection processing (step S608). In step S701, the resource management unit 205 sets m to 1, where m is the number of times the detection processing is to be repeated. Next, in step S702, the image acquisition unit 201 acquires an image from the nth image capturing apparatus based on an instruction from the resource management unit 205. Next, in step S703, the compression unit 202 compresses the image transmitted from the nth image capturing apparatus. In a case where a high resolution is designated, the compression unit 202 compresses the image so that a high-resolution image is generated. As described above, in a case where the compression rate is changed, the compression unit 202 performs compression using the changed compression rate.

Next, in step S704, the secondary detection unit 206 performs the secondary event detection. The secondary event detection can be the processing using the same detection device as that in the primary event detection or the processing using a different detection device. Next, in step S705, the resource management unit 205 checks whether the number of repetitions m is equal to mₘₐₓ, where mₘₐₓ, is the number of times the processing is to be executed that is set to the resource management unit 205. For example, in a case where the processing is to be repeated three times, mₘₐₓ is 3. In a case where the number of repetitions m is equal to mₘₐₓ. (YES in step 705), the processing proceeds to step S707. In a case where the number of repetitions m is not equal to mₘₐₓ, i.e., m is less than mₘₐₓ (NO in step S705), the processing proceeds to step S706. In step S706, the resource management unit 205 adds one to the number of repetitions m, and then the processing proceeds to step S702.

In step S707, the secondary detection unit 206 determines a comprehensive detection result based on a majority of the plurality of detection results. The processing of determining the comprehensive detection result can be any processing that refers to the plurality of detection results, and specific processing is not limited to that in the exemplary embodiments. As another example, in a case where an event detection score is calculated, the secondary detection unit 206 can determine the comprehensive detection result based on a mean value or median value of scores or the number of times the scores exceeds a threshold value.

Referring back to FIG. 6, after the processing in step S608, the processing proceeds to step S609. In step S609, the detection information transmission unit 207 checks whether an event is detected in the second detection processing. In a case where an event is detected (YES in step S609), the processing proceeds to step S610. In a case where an event is not detected (NO in step S609), the processing proceeds to step S611.

In step S610, the detection information transmission unit 207 transmits detection information to the display apparatus 120. This processing is an example of output processing. If the detection information is received, the display apparatus 120 displays the detection information on the display unit 124. A monitoring person can check the displayed detection information and take action such as checking an image acquired from the image capturing apparatus that has captured the image from which the event is detected.

As described above, in a case where an event is detected in the primary event detection, the information processing apparatus 100 according to the present exemplary embodiment allocates the resources preferentially to the processing of monitoring an image acquired from the image capturing apparatus in detail. Thus, accuracy of event detection from a captured image increases even in a case where a target of the information processing apparatus 100 is images acquired from each of the plurality of image capturing apparatuses.

A first modified example of the first exemplary embodiment will be described below. In a case where the information processing apparatus 100 detects an event in secondary detection processing and transmits detection information to the display apparatus 120, it is expected that a monitoring person actually checks the image. Thus, in this case, the information processing apparatus 100 can exclude an image captured by the image capturing apparatus that has captured the event-detected image from a processing target in the primary event detection for a predetermined period of time. Further, the information processing apparatus 100 can reduce the number of times the first detection processing is to be performed on the image acquired from this image capturing apparatus so that the number of times becomes smaller than the number of times the first detection processing is to be performed on the images acquired from the other image capturing apparatuses. In this way, the information processing apparatus 100 can set a lower priority of the primary event detection to the image captured by the image capturing apparatus having captured the event-detected image than a priority set to the images captured by the other image capturing apparatuses. As a result, the number of image capturing apparatuses to be processed by the calculation unit 101 is temporarily decreased, so that more resources of the calculation unit 101 can be allocated to the other image capturing apparatuses.

A second modified example of the first exemplary embodiment will be described below. In a case where the processing proceeds to step S602 again after the second detection processing is performed in step S608 in the information processing illustrated in FIG. 6, the information processing apparatus 100 can change the image compression method to obtain an image with a lower resolution. In this way, the processing time of the primary event detection is reduced, and throughput of the information processing apparatus 100 increases. The image compression method to be employed in this case can be preset or, as another example, can be set automatically in association with a history, such as the number of times the event detection is previously performed or the event detection timing.

A third modified example of the first exemplary embodiment will be described below. Instead of processing the image acquired from each of the three image capturing apparatuses as the target, the information processing apparatus 100 can perform the event detection only on the image acquired from one image capturing apparatus and can change the resource allocation between the event detection and a predetermined task other than the event detection. More specifically, for example, in a case where the primary event detection, a task A, and a task B are to be executed in this order, if an event is detected in the primary event detection, the information processing apparatus 100 performs not the task A but the second detection processing after the primary event detection.

A fourth modified example of the first exemplary embodiment will be described below. While the information processing apparatus 100 includes the compression unit 202 in the present exemplary embodiment, the image capturing apparatus 110 can include the compression unit 202. In this example, if a target of the secondary detection processing is a high-resolution image, the image acquisition unit 201 transmits an instruction to change the compression rate to the image capturing apparatus 110, acquires a high-resolution image from the image capturing apparatus 110, and transmits the high-resolution image to the secondary detection unit 206.

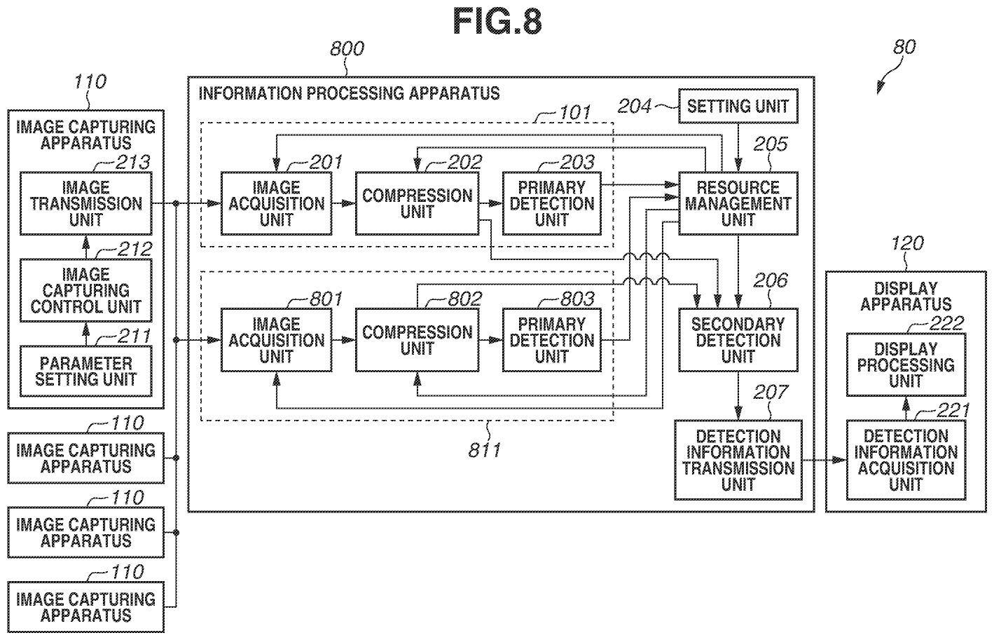

Next, an information processing system according to a second exemplary embodiment will be described below, mainly in terms of a difference from the information processing system according to the first exemplary embodiment. FIG. 8 is a diagram illustrating a functional configuration of an information processing system 80 according to the second exemplary embodiment. The information processing system 80 according to the second exemplary embodiment will be described below, mainly in terms of a difference from the information processing system 10 according to the first exemplary embodiment.

In the information processing system 80, an information processing apparatus 800 includes two calculation units as a hardware configuration. More specifically, the information processing apparatus 800 includes a calculation unit 811 in addition to the calculation unit 101. Further, the information processing apparatus 800 includes an image acquisition unit 801, a compression unit 802, and a primary detection unit 803 in addition to the image acquisition unit 201, the compression unit 202, and the primary detection unit 203 as a functional configuration. The image acquisition unit 201, the compression unit 202, and the primary detection unit 203 are implemented by the calculation unit 101, whereas the image acquisition unit 801, the compression unit 802, and the primary detection unit 803 are implemented by the calculation unit 811. In other words, different resources are used for the functional units 201 to 203 and the functional units 801 to 803 up to the primary detection unit.

The calculation unit 101 and the calculation unit 811 share the processing on the images acquired from the plurality of image capturing apparatuses 110 connected to the information processing apparatus 800. In the present exemplary embodiment, the four image capturing apparatuses 110 that are first to fourth image capturing apparatuses are connected to the information processing apparatus 800, and the calculation unit 101 is responsible for the first and second image capturing apparatuses whereas the calculation unit 811 is responsible for the third and fourth image capturing apparatuses. The calculation unit 101 performs the primary event detection on an image acquired from the first image capturing apparatus and an image acquired from the second image capturing apparatus in this order, and the calculation unit 811 performs the primary event detection on an image acquired from the third image capturing apparatus and an image acquired from the fourth image capturing apparatus in this order. The calculation unit 101 and the calculation unit 811 simultaneously perform the processing on the image acquired from the first image capturing apparatus and the image acquired from the third image capturing apparatus and simultaneously perform the processing on the image acquired from the second image capturing apparatus and the image acquired from the fourth image capturing apparatus.

The information processing by the information processing apparatus 800 according to the present exemplary embodiment will be described below with reference to FIGS. 6 and 7. The calculation units 101 and 811 each acquire a processing target image in step S602, compress the image in step S603, and perform the primary event detection in step S604. The processing in steps S603 and S604 is first detection processing. If an event is detected in the primary event detection (YES in step S605), the processing proceeds to step S606.

In the present exemplary embodiment, a case where the calculation unit 101 detects an event in the primary event detection on the image acquired from the first image capturing apparatus will be described as an example. In this case, in step S606, the resource management unit 205 determines the second detection processing based on the event detected in the primary event detection. In the present exemplary embodiment, there is described a case where the processing of repeating the detection processing three times is determined as the second detection processing. Next, in step S607, the resource management unit 205 changes the resource allocation of the calculation units 101 and 811. More specifically, the resource management unit 205 changes the resource allocation of the calculation units 101 and 811 from the primary event detection on an image acquired from the next image capturing apparatus, to which the resources are supposed to be allocated, to the secondary event detection on an image previously determined as a processing target. In other words, the calculation units 101 and 811 are allocated to the resources for the secondary event detection on the image acquired from the first and third image capturing apparatuses, respectively.

Next, in step S608, the calculation unit 101 acquires an image from the first image capturing apparatus, compresses the image, and performs the secondary event detection (steps S701 to S704 in FIG. 7). Similarly, the calculation unit 811 acquires an image from the third image capturing apparatus, compresses the image, and performs the secondary event detection (steps S701 to S704 in FIG. 7). The calculation units 101 and 811 simultaneously perform the processing in steps S701 to S704. As another example, the calculation units 101 and 811 can perform the processing in steps S701 to S704 at shifted timings on images captured at different time points as processing targets. Further, the calculation units 101 and 811 can perform the secondary event detection using the same event detection device or can perform the secondary event detection using a different event detection device. The calculation unit 101 repeats the processing in steps S701 to S704 twice, and the calculation unit 811 performs the processing in steps S701 to S704 once, whereby the processing is performed three times.

A case is cited where the calculation unit 101 detects an event in the primary event detection on the image acquired from the first image capturing apparatus and the calculation unit 811 detects an event in the primary event detection on the image acquired from the third image capturing apparatus in the information processing apparatus 800 according to the present exemplary embodiment. In this case, the resource management unit 205 allocates the resource of the calculation unit 101 to the second detection processing on the image acquired from the first image capturing apparatus and allocates the resource of the calculation unit 811 to the second detection processing on the image acquired from the third image capturing apparatus. Then, the calculation units 101 and 811 execute the second detection processing on the image acquired from the first image capturing apparatus and the image acquired from the third image capturing apparatus, respectively.

As described above, in a case where the information processing apparatus 800 includes a plurality of calculation units, if an event is detected in the primary event detection, the resources of the plurality of calculation units are allocated to the processing of monitoring the image acquired from the image capturing apparatus in detail. In this way, even in a case where the information processing apparatus 100 processes the images acquired from the plurality of image capturing apparatuses as targets, the accuracy of event detection from the captured images increases.

A modified example of the present exemplary embodiment will be described below. While the case where the information processing apparatus 800 includes the two calculation units 101 and 811 is described as an example in the present exemplary embodiment, the information processing apparatus 800 can include three or more calculation units. In such a case, similarly, if an event is detected, the resources are allocated to the calculation units.

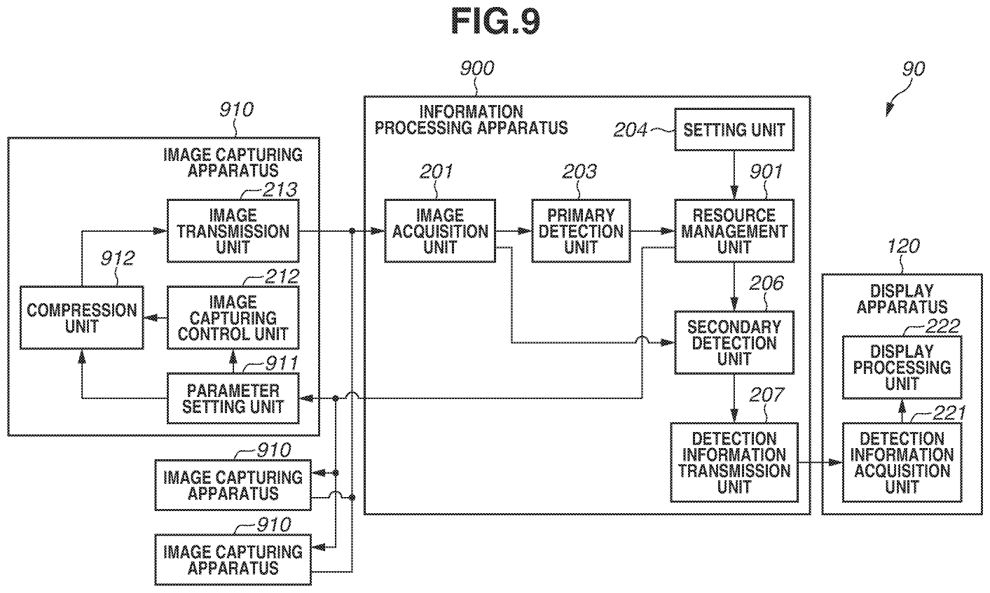

Next, an information processing system according to a third exemplary embodiment will be described below, mainly in terms of a difference from the information processing systems according to the other exemplary embodiments. FIG. 9 is a functional configuration illustrating an information processing system 90 according to the third exemplary embodiment. In the information processing system 90 according to the third exemplary embodiment, an image capturing apparatus 910 includes a compression unit 912. In a case where the second detection processing includes changing the compression rate, an information processing apparatus 900 changes the resource allocation of the image capturing apparatus 910.

In the present exemplary embodiment, the image capturing apparatus 910 includes the compression unit 912 in addition to the image capturing control unit 212, the image transmission unit 213, and a parameter setting unit 911. The compression unit 912 is similar to the compression unit 202 in the other exemplary embodiments and performs image compression. The parameter setting unit 911 sets the compression rate to the compression unit 912.

The information processing apparatus 900 is different in functional configuration from the information processing apparatus 100 according to the first exemplary embodiment in that the information processing apparatus 900 does not include the compression unit 202. Further, in a case where the secondary detection processing includes changing the compression rate, a resource management unit 901 transmits an instruction to change the compression rate to the image capturing apparatus 110 via the communication unit 103.

In the present exemplary embodiment, in the case where the secondary detection processing includes changing the compression rate, the resource management unit 901 first transmits the instruction to change the compression rate to the image capturing apparatus 910 that is a processing target. In response, if the image capturing apparatus 910 receives the change instruction, the parameter setting unit 911 sets a compression rate based on the change instruction to the compression unit 912. Then, the compression unit 912 compresses the acquired image under control of the image capturing control unit 212 using the set compression rate. Then, the image transmission unit 213 transmits the compressed image to the information processing apparatus 900. In the information processing apparatus 900, the image acquisition unit 201 acquires the image compressed using the compression rate based on the change instruction, and the secondary detection unit 206 performs the secondary event detection on the compressed image.

As described above, the information processing apparatus 900 also manages the resources of the other apparatuses.

A first modified example of the third exemplary embodiment will be described below. In the present exemplary embodiment, the case where the image capturing apparatus 910 changes the compression rate is described as an example. As another example, in a case where the image capturing apparatus 910 is to perform the event detection, allocation of the resource of the image capturing apparatus 910 as a resource for the event detection can be changed. In this case, in the secondary detection processing, the information processing apparatus 900 transmits an instruction to execute the secondary event detection to the image capturing apparatus 910. In response, if the image capturing apparatus 910 receives the execution instruction, the image capturing apparatus 910 performs the event detection. As described above, in the information processing system according to the third exemplary embodiment, the information processing apparatus 900 can allocate the resources of the other apparatuses to at least part of the secondary detection processing.

As another example, in a case where the information processing apparatus 900 detects an event, the image capturing apparatus 910 can increase a frame rate. In such a case, the information processing apparatus 900 transmits an instruction to change the frame rate to the image capturing apparatus 910. If the image capturing apparatus 910 receives the change instruction, the image capturing apparatus 910 changes the frame rate of image transmission based on the change instruction.

Further, in a second modified example, the information processing apparatus 900 manages a storage apparatus of the information processing apparatus 900 and a network that connects the information processing apparatus 900 with the image capturing apparatus 910 as resources in addition to those described above.

While the exemplary embodiments of the present invention have been described in detail, the present invention is not limited to any specific exemplary embodiments and can be modified and changed in various ways within the spirit of the claimed invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™) a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-080895, filed Apr. 22, 2019, which is hereby incorporated by reference herein in its entirety.

What is claimed is:

1. An information processing apparatus comprising:
a first detection unit configured to detect an event from a captured image through first detection processing;
a resource management unit configured to allocate a resource allocated to predetermined processing to second detection processing different from the first detection processing in a case where the event is detected through the first detection processing; and
a second detection unit configured to detect an event from the captured image through the second detection processing using the resource allocated by the resource management unit.

2. The information processing apparatus according to claim 1, wherein the resource management unit allocates the resource allocated to the first detection processing to the second detection processing.

3. The information processing apparatus according to claim 1, wherein the resource management unit manages a calculation apparatus as the resource.

4. The information processing apparatus according to claim 1, wherein the resource management unit manages a storage apparatus as the resource.

5. The information processing apparatus according to claim 1, further comprising an output unit configured to output detection information indicating that the event is detected in a case where the event is detected by the second detection unit.

6. The information processing apparatus according to claim 1, wherein a number of times the event detection is performed in the second detection processing is greater than a number of times the event detection is performed in the first detection processing.

7. The information processing apparatus according to claim 1, wherein the second detection processing is detection processing to be performed on an image with a lower compression rate than a compression rate in the first detection processing.

8. The information processing apparatus according to claim 1, wherein the first detection unit performs the first detection processing on an image captured by each of a plurality of image capturing apparatuses in order.

9. The information processing apparatus according to claim 8, wherein, in a case where the event is detected through the second detection processing, the first detection unit stops the first detection processing on an image for a predetermined period of time, the image captured by the image capturing apparatus having captured the captured image from which the event is detected.

10. The information processing apparatus according to claim 1,
wherein the first detection unit detects a plurality of events,
wherein the information processing apparatus further comprises a detection processing determination unit configured to determine the second detection processing based on a type of the event detected through the first detection processing, and
wherein the second detection unit performs the second detection processing determined by the detection processing determination unit.

11. The information processing apparatus according to claim 1, wherein the first detection unit and the second detection unit detect an abnormal action of a person as the event.

12. The information processing apparatus according to claim 1, wherein the first detection unit and the second detection unit detect presence of a specific object as the event.

13. An information processing system comprising:
an information processing apparatus; and
an image capturing apparatus connected to the information processing apparatus via a network and configured to capture the captured image,
wherein the information processing apparatus comprises:
a first detection unit configured to detect an event from a captured image through first detection processing;
a resource management unit configured to allocate a resource allocated to predetermined processing to second detection processing different from the first detection processing in a case where the event is detected through the first detection processing; and
a second detection unit configured to detect an event from the captured image through the second detection processing using the resource allocated by the resource management unit.

14. The information processing system according to claim 13, wherein the resource management unit manages the network as the resource.

15. The information processing system according to claim 13, further comprising a plurality of image capturing apparatuses connected to the information processing apparatus via the network.

16. The information processing system according to claim 15, wherein the resource management unit manages the plurality of image capturing apparatuses as the resource.

17. The information processing system according to claim 13,
wherein the information processing apparatus includes a transmission unit configured to transmit an instruction to change a compression rate to the image capturing apparatus in a case where the event is detected through the first detection processing,
wherein the image capturing apparatus includes a transmission unit configured to transmit the captured image compressed using the changed compression rate based on the instruction to the information processing apparatus, and
wherein the second detection unit detects the event from a processing target that is the captured image compressed using the changed compression rate.

18. The information processing system according to claim 13,
wherein the information processing apparatus includes a transmission unit configured to transmit an instruction to change a frame rate to the image capturing apparatus in a case where the event is detected through the first detection processing,
wherein the image capturing apparatus includes a transmission unit configured to transmit the captured image to the information processing apparatus at the changed frame rate based on the instruction, and
wherein a second detection unit detects the event from a processing target that is the captured image received at the changed frame rate.

19. An information processing method executed by an information processing system, the method comprising:
detecting an event from a captured image through first detection processing;
allocating a resource allocated to predetermined processing to second detection processing different from the first detection processing in a case where the event is detected through the first detection processing; and
detecting an event from the captured image through the second detection processing using the allocated resource.

20. A non-transitory computer-readable storage medium that stores a program for causing a computer to function as:
a first detection unit configured to detect an event from a captured image through first detection processing;
a resource management unit configured to allocate a resource allocated to predetermined processing to second detection processing different from the first detection processing in a case where the event is detected through the first detection processing; and
a second detection unit configured to detect an event from the captured image through the second detection processing using the resource allocated by the resource management unit.
